(19) United States
(12) Patent Application Publication
(10) Pub. No.: US 2026/0246820 A1
(43) Pub. Date: Aug. 20, 2026

(54) SYSTEMS AND METHODS FOR UNIQUELY DIFFERENTIATING MEDIA SOURCE IDENTIFIERS OF MCVIDEO COMMUNICATION PARTICIPANTS

(71) Applicant: SAMSUNG ELECTRONICS CO., LTD., Gyeonggi-do (KR)

(72) Inventors: Kiran Gurudev KAPALE, Bangalore (IN); Arunprasath RAMAMOORTHY, Bangalore (IN); Naveen KOLATI, Bangalore (IN)

(21) Appl. No.: 19/157,135

(22) PCT Filed: Feb. 5, 2024
(86) PCT No.: PCT/KR2024/001649

§ 371 Date: Aug. 15, 2025

(30) Foreign Application Priority Data
Feb. 17, 2023 (IN) 202341010897
Jan. 22, 2024 (IN) 202341010897

(51) Int. Cl. H04L 65/1069; H04L 65/1104; H04L 65/65

(52) U.S. Cl. CPC H04L 65/1069; H04L 65/1104; H04L 65/65

(57) ABSTRACT

The disclosure relates to a 5G or 6G communication system for supporting a higher data transmission rate. Embodiments disclosed herein relate to a system (100) and methods (200, 300, 400) for uniquely differentiating media source identifiers of mission critical video (MCVideo) communication participants. The methods (200, 300, 400) provide uniqueness to the media source identifiers of the MCVideo communication participants to avoid collision of media source identifiers which are used in real-time transport protocol (RTP) packets. Further, the methods (200, 300, 400) provide a granted transmission participant with a uniquely differentiable media source identifier, if the MCVideo communication setup is initiated along with an implicit transmission request. The unique media source identifier can be used for sending audio and video media data using the RTP packets.

### TECHNICAL FIELD

Embodiments disclosed herein relate to wireless communication networks, and more particularly to uniquely differentiating media source identifiers of the Mission Critical Video (MCVideo) communication participants, wherein mission critical services are used by public safety communities (such as police, military, fire services, ambulance crews, and many more) in their operations that require high reliability, speed, quick accessibility, and low latency operational support.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

Participants in Mission Critical Video (MCVideo) communication are allowed to opt in and opt out to receive the media transmission from other participants who are transmitting the audio and video. If multiple participants are transmitting audio and video media at the same time without both of the transmitting participants receiving each other's media, the chances of collision of media source identifier at receiving participants is possible and both the transmitting participants will not be able to detect this collision. This can result in improper rendering of media packets at receiving participants.

The existing specification has a mechanism in which if the participants request for transmission of media (for example, audio and video), then the server provides a unique media source identifier. However, each of the audio and video media should have its own media source identifier. There is no existing mechanism, if the MCVideo communication setup is initiated along with an implicit transmission request, then the granted transmission participant provided with uniquely differentiable media source identifier which can be used in sending of audio and video media data using RTP packets.

Hence, there is a need in the art for solutions which will overcome the above mentioned drawback(s), among others.

### DISCLOSURE OF INVENTION

### Solution to Problem

The principal aspect of the embodiments herein is to disclose methods and systems for uniquely differentiating media source identifiers of Mission Critical Video (MCVideo) communication participants, wherein embodiments herein provide uniqueness to the media source identifiers of the MCVideo communication participants to avoid collision of media source identifiers which are used in Real-time Transport Protocol (RTP) packets.

Another aspect of the embodiments herein is to disclose methods and systems for providing a granted transmission participant with a uniquely differentiable media source identifier, if the MCVideo communication setup is initiated along with an implicit transmission request, wherein the unique media source identifier can be used for sending audio and video media data using RTP packets.

Accordingly, the embodiments herein provide a method for handling one or more media source identifiers of one or more Mission Critical Video (MCVideo) communication clients. The method comprises receiving, by a MCVideo server, at least one call setup request initiated by at least one MCVideo client for a MCVideo communication session. The call setup request comprises at least one of an audio media data, and a video media data. The method comprises generating, by the MCVideo server, at least one unique media source identifier for at least one of the audio media data, and the video media data. Thereafter, the method comprises sending, by the MCVideo server, the generated unique media source identifier to the MCVideo client in at least one call setup response.

Accordingly, the embodiments herein provide a MCVideo server. The MCVideo server comprises a processor. The processor is configured to receive at least one call setup request initiated by at least one MCVideo client for a MCVideo communication session. The processor is configured to generate at least one unique media source identifier for at least one of the audio media data, and the video media data. Further, the processor is configured to send the generated unique media source identifier to the MCVideo client in at least one call setup response.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a system for handling one or more media source identifiers of one or more MCVideo communication clients by a MCVideo server, according to embodiments as disclosed herein;

FIG. 2 depicts a method for handling one or more media source identifiers of one or more MCVideo communication clients by the MCVideo server, according to embodiments as disclosed herein;

FIG. 3 depicts an alternate method for handling one or more media source identifiers of one or more MCVideo communication clients by the MCVideo server, according to embodiments as disclosed herein;

FIG. 4 depicts a method of performing the MCVideo communication session by at least one MCVideo client, according to embodiments as disclosed herein;

FIG. 5a illustrates a call flow diagram to negotiate media source identifier for both audio and video media during call setup with an implicit transmission request, according to embodiments as disclosed herein;

FIG. 5b illustrates a call flow diagram to negotiate media source identifier for both audio and video media during call setup with an implicit transmission request, according to embodiments as disclosed herein; and

FIG. 6 depicts an another alternate method for handling one or more media source identifiers of one or more MCVideo communication clients by the MCVideo server by generating unique media source identifiers for both audio and video media during call setup when the call setup is requested with implicit transmission request, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

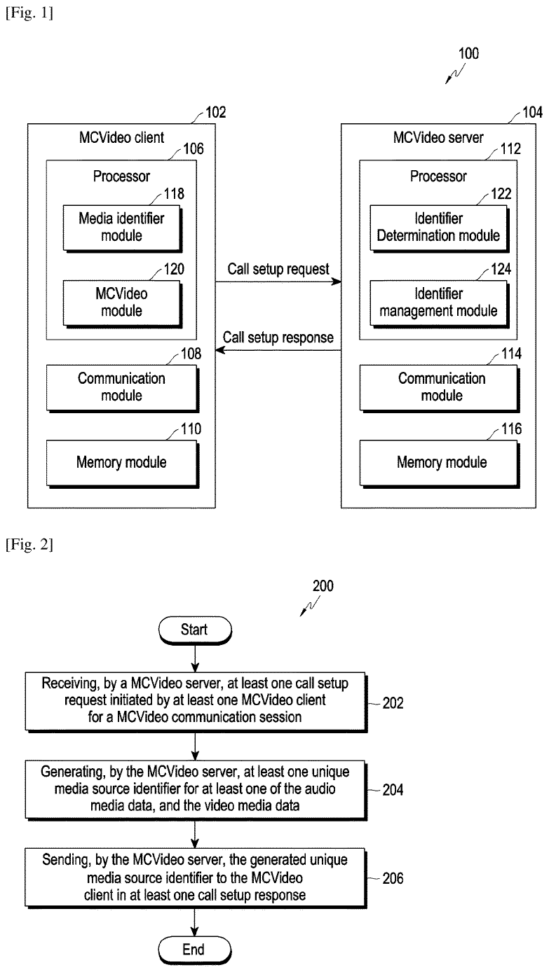

The embodiments herein achieve a system and method for uniquely differentiating the media source identifiers of the Mission Critical Video (MCVideo) communication participants. Referring now to the drawings, and more particularly to FIGS. 1 through 6, where similar reference characters denote corresponding features consistently throughout the figures, there are shown embodiments.

FIG. 1 depicts a system 100 for handling one or more media source identifiers of one or more MCVideo communication clients by a MCVideo server. The system 100 comprises at least one MCVideo client 102, and a MCVideo server 104. The MCVideo server 104 ensures in uniquely differentiating the media source identifiers of the MCVideo client 102 or participant. The MCVideo client 102 further comprises a processor 106, a communication module 108, and a memory module 110. The MCVideo server 104 provides uniqueness to the media source identifier of the MCVideo client 102 to avoid collision of media source identifiers which are used in Real-time Transport Protocol (RTP) packets. The MCVideo server 104 provides a granted transmission participant with a uniquely differentiable media source identifier, if the MCVideo communication setup is initiated along with implicit transmission request. The media source identifier can be used for sending of audio and video media data using RTP packets.

In an embodiment herein, the processor 106 of the MCVideo client 102 comprises a media identifier module 118, and a MCVideo module 120. The media identifier module 118 can send at least one call setup request to the MCVideo server 104 for a MCVideo communication session. The call setup request comprises at least one of an audio media data, a video media data, and so on. The call setup request can be initiated with an implicit transmission request. The call setup request comprises at least one media source identifier for the audio media data, and the video media data. In an embodiment herein, the media identifier module 118 can receive back the media source identifier, from the MCVideo server 104, in at least one call setup response, if the media source identifier for the audio media data, and the video media data is uniquely differentiable. In an embodiment herein, the media identifier module 118 can receive at least one unique media source identifier generated by the MCVideo server 104 in the call setup response, if the media source identifier for the audio media data, and the video media data is not uniquely differentiable.

In an embodiment herein, the media identifier module 118 can include the media source identifier, and the unique media source identifier in a Session Description Protocol (SDP). The media identifier module 118 can populate the media source identifier in the SDP using a media attribute a=ssrc for each media line (m-line) for at least one of the audio media data, and the video media data. The media identifier module 118 can add the media source identifier to the m-line of a media plane control channel in the SDP, for at least one of the audio media data, and the video media data, using mc_audio_ssrc and mc_video_ssrc media attributes.

In an embodiment herein, the MCVideo module 120 can include the generated unique media source identifier in one or more RTP packets. The MCVideo module 120 can transmit at least one of an audio, and a video using the RTP packets during the MCVideo communication session.

In an embodiment herein, the MCVideo server 104 comprises a processor 112, a communication module 114, and a memory module 116. The processor 112 further comprises an identifier determination module 122, and a identifier management module 124.

In an embodiment herein, the identifier determination module 122 can receive the call setup request initiated by the MCVideo client 102 for the MCVideo communication session. The call setup request comprises at least one media source identifier for at least one of the audio media data, and the video media data. The identifier determination module 122 can determine whether the media source identifier for at least one of the audio media data, and the video media data is uniquely differentiable.

In an embodiment herein, the identifier management module 124 can return back the media source identifier to the MCVideo client 102 in the call setup response, if the media source identifier for at least one of the audio media data, and the video media data is uniquely differentiable. In an embodiment herein, the identifier management module 124 can generate at least one unique media source identifier for at least one of the audio media data, and the video media data. In an embodiment herein, the identifier management module 124 can generate the unique media source identifier for at least one of the audio media data, and the video media data, if the media source identifier for at least one of the audio media data, and the video media data is not uniquely differentiable. The identifier determination module 122 can send the generated unique media source identifier to the MCVideo client 102 in the call setup response.

In an embodiment herein, the identifier management module 124 can return at least one of the media source identifier and the generated unique media source identifier to the MCVideo client 102 with the media plane control channel using the mc_audio_ssrc and mc_video_ssrc media attributes. In an embodiment herein, the identifier management module 124 can transmit at least of the media source identifier, and the unique media source identifier to the MCVideo client 102 in an explicit transmission grant message, if an mc_granted media attribute is not included in the SDP of at least one of the call setup request, and the call setup response, or the mc_granted media attribute is supported.

In an embodiment herein, the processor 106 and the processor 112 can process and execute data of a plurality of modules of the MCVideo client 102 and the MCVideo server 104 respectively. The processor 106 and the processor 112 can be configured to execute instructions stored in the memory module 110 and the memory module 116 respectively. The processor 106 and the processor 112 may comprise one or more of microprocessors, circuits, and other hardware configured for processing. The processor 106 and the processor 112 can be at least one of a single processer, a plurality of processors, multiple homogeneous or heterogeneous cores, multiple Central Processing Units (CPUs) of different kinds, microcontrollers, special media, and other accelerators. The processor 106 and the processor 112 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the plurality of modules of the processor 106 and the processor 112 of the MCVideo client 102 and the MCVideo server 104 can communicate via the communication module 108 and the communication module 114 respectively. The communication module 108 and the communication module 114 may be in the form of either a wired network or a wireless communication network module. The wireless communication network may comprise, but not limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory module 110 and the memory module 116 may comprise one or more volatile and non-volatile memory components which are capable of storing data and instructions of the modules of the MCVideo client 102 and the MCVideo server 104 to be executed. Examples of the memory module 110 and the memory module 116 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 110 and the memory module 116 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 110 and the memory module 116 may, in some examples, be considered a non-transitory storage medium. The term “non-transitory” may indicate that the storage medium is not embodied in a carrier wave or a propagated signal. However, the term “non-transitory” should not be interpreted to mean that the memory module 110 and the memory module 116 are non-movable. In certain examples, a non-transitory storage medium may store data that can, over time, change (for example, in Random Access Memory (RAM) or cache).

FIG. 1 shows example modules of the MCVideo client 102 and the MCVideo server 104 respectively, but it is to be understood that other embodiments are not limited thereon. In other embodiments, the MCVideo client 102 and the MCVideo server 104 may include less or more number of modules. Further, the labels or names of the modules are used only for illustrative purpose and does not limit the scope of the invention. One or more modules can be combined together to perform same or substantially similar function in the MCVideo client 102 and the MCVideo server 104 respectively.

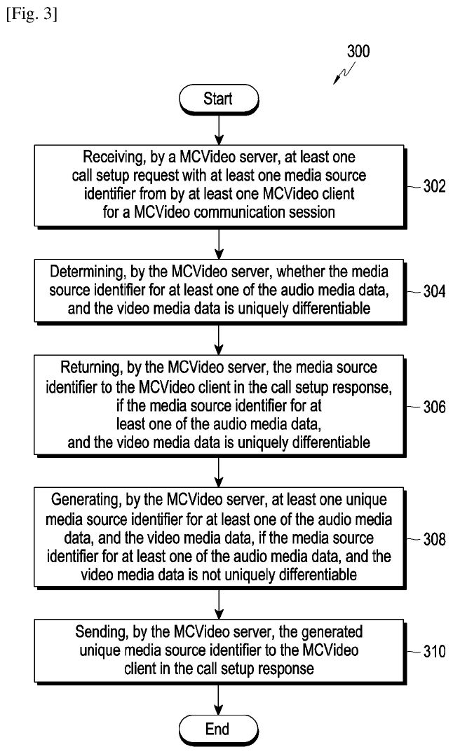

FIG. 2 depicts a method 200 for handling one or more media source identifiers of one or more MCVideo communication clients by the MCVideo server 104. The method 200 comprises receiving, by the MCVideo server 104, at least one call setup request initiated by at least one MCVideo client 102 for a MCVideo communication session, as depicted in step 202. The call setup request is initiated with an implicit transmission request. The call setup request comprises at least one media source identifier for at least one of the audio media data, and the video media data. The method 200 further comprises generating, by the MCVideo server 104, at least one unique media source identifier for at least one of the audio media data, and the video media data, as depicted in step 204. Thereafter, the method 200 comprises sending, by the MCVideo server 104, the generated unique media source identifier to the MCVideo client 102 in at least one call setup response, as depicted in step 206.

The various actions in method 200 may be performed in the order presented, in a different order or simultaneously. Further, in some embodiments, some actions listed in FIG. 2 may be omitted.

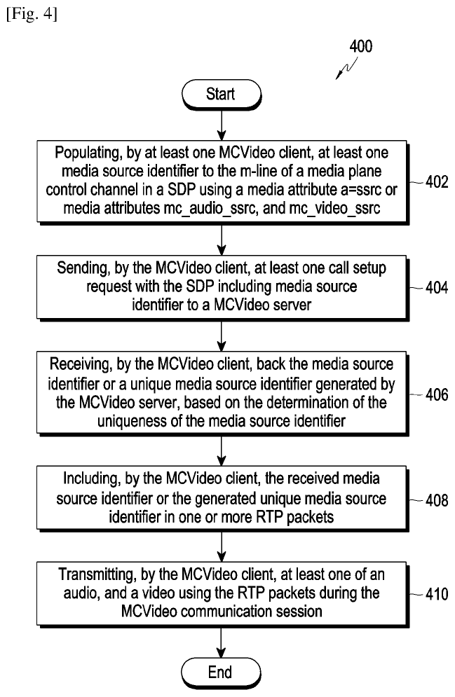

FIG. 3 depicts an alternate method 300 for handling one or more media source identifiers of one or more MCVideo communication clients by the MCVideo server 104. The method 300 comprises receiving, by the MCVideo server 104, at least one call setup request with at least one media source identifier from at least one MCVideo client 102 for a MCVideo communication session, as depicted in step 302. The media source identifier is configured for at least one of the audio media data, and the video media data. The method 300 comprises determining, by the MCVideo server 104, whether the media source identifier for at least one of the audio media data, and the video media data is uniquely differentiable, as depicted in step 304.

Thereafter, the method 300 comprises returning, by the MCVideo server 104, the media source identifier to the MCVideo client 102 in the call setup response, if the media source identifier for at least one of the audio media data, and the video media data is uniquely differentiable, as depicted in step 306. The method 300 comprises generating, by the MCVideo server 104, at least one unique media source identifier for at least one of the audio media data, and the video media data, if the media source identifier for at least one of the audio media data, and the video media data is not uniquely differentiable, as depicted in step 308. The method 300 comprises sending, by the MCVideo server 104, the generated unique media source identifier to the MCVideo client 102 in the call setup response, as depicted in step 310.

The various actions in method 300 may be performed in the order presented, in a different order or simultaneously. Further, in some embodiments, some actions listed in FIG. 3 may be omitted.

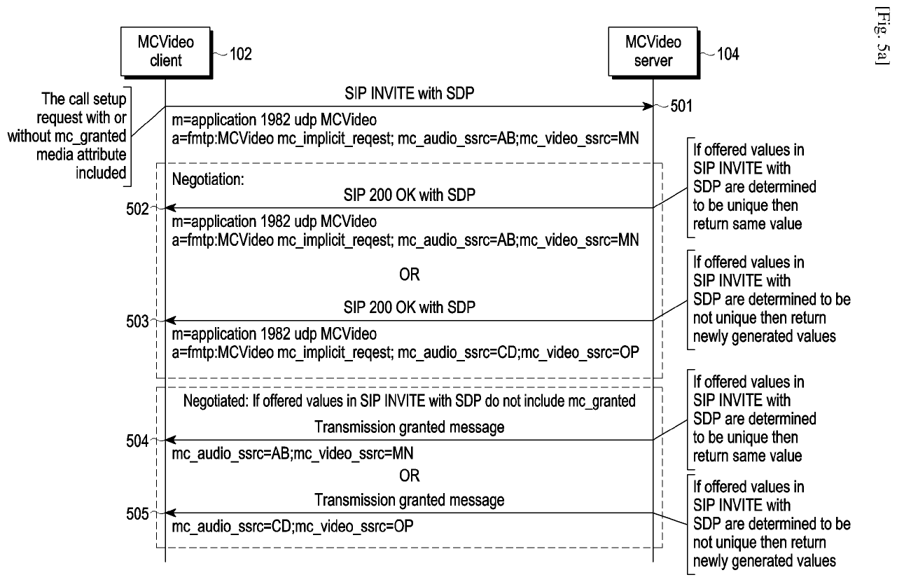

FIG. 4 depicts a method 400 of performing the MCVideo communication session by at least one MCVideo client 102. The method 400 comprises populating, by the MCVideo client 102, at least one media source identifier to the m-line of a media plane control channel in a SDP using a media attribute a=ssrc or media attributes mc_audio_ssrc, and mc_video_ssrc, as depicted in step 402. The method 400 comprises sending, by the MCVideo client 102, at least one call setup request with the SDP including media source identifier to the MCVideo server 104, as depicted in step 404.

Thereafter, the method 400 comprises receiving, by the MCVideo client 102, back the media source identifier or a unique media source identifier generated by the MCVideo server 104, based on the determination of the uniqueness of the media source identifier, as depicted in step 406. The method 400 comprises including, by the MCVideo client 102, the received media source identifier or the generated unique media source identifier in one or more RTP packets, as depicted in step 408. Later, the method 400 comprises transmitting, by the MCVideo client 102, at least one of an audio, and a video using the RTP packets during the MCVideo communication session, as depicted in step 410.

The various actions in method 400 may be performed in the order presented, in a different order or simultaneously. Further, in some embodiments, some actions listed in FIG. 4 may be omitted.

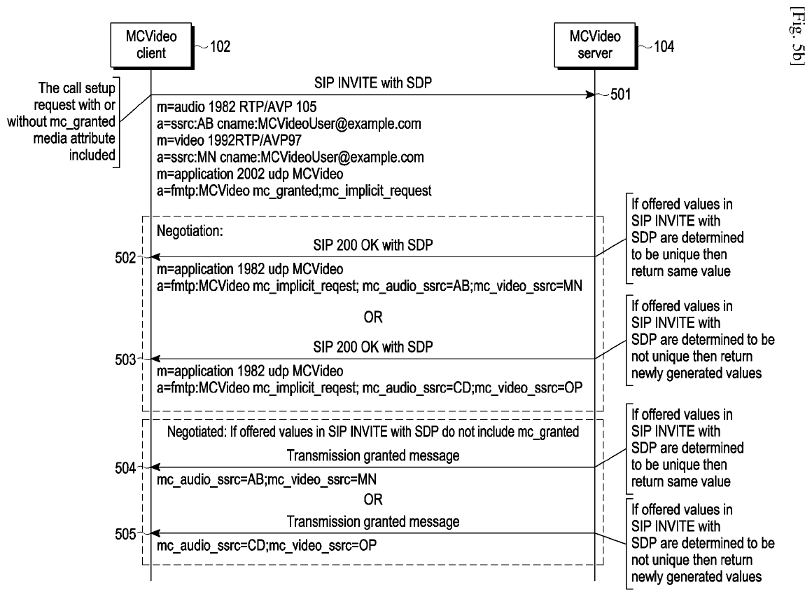

FIGS. 5a and 5b illustrate a call flow diagram to negotiate media source identifier for both audio and video media during call setup with an implicit transmission request. The MCVideo client 102 can populate the media source identifier in SDP using media attribute a=ssrc for each of the media m-line for audio media and video media. Alternatively, the media source identifier for audio media and video media are added to m-line associated with the media plane control channel as mc_audio_ssrc and mc_video_ssrc or with any other media attribute name. The call setup request is initiated, by the MCVideo client 102, with or without mc_granted media attribute included. The MCVideo client 102 transmits a Session Initiation Protocol (SIP) invite request with SDP to the MCVideo server 104, as depicted in step 501.

The SDP is included in the call setup request and in the call setup response. Further, the MCVideo server 104 returns the negotiated values. If the offered media source identifier for both audio and video media are uniquely differentiable, then the MCVideo server 104 returns same values (as that of offered) in the call setup response, as depicted in step 502, with SIP 200 OK with SDP. If the offered media source identifier for both is not uniquely differentiable, then the MCVideo server 104 generates a new media source identifier for both and returns the values in the call setup response, as depicted in step 503, with SIP 200 OK with SDP. The MCVideo server 104 uses the media plane control channel with mc_audio_ssrc and mc_video_ssrc attribute to return the media source identifier or with any other media attribute name.

In this example, if the media source identifier values are not in use, then the MCVideo server 104 returns the offered value of the media source identifier for both audio and video media. The MCVideo server 104 shares the media source identifiers to the MCVideo client 102 in 200 OK response. In an embodiment herein, the MCVideo server 104 can send the media source identifiers in an explicit transmission grant message, as depicted in steps 504 and 505, if offered values in SIP INVITE with SDP do not include mc_granted.

FIG. 5a is an example call flow diagram using media attributes mc_audio_ssrc, and mc_video_ssrc. FIG. 5b is an example call flow diagram using a media attribute a=ssrc.

Following examples with reference to FIG. 5a is as given below:
1) Offer: with mc_granted, and MCVideo server returns same value back for both audio and video

$$m = application 1982 udp MCVideo$$

$$a = fmtp : MCVideo mc\_granted ; mc\_implicit \_request ;$$

$$mc\_audio \_ssrc = 1024 ; mc\_video \_ssrc = 1048$$

Answer:

$$m = application 2015 udp MCVideo$$

$$a = fmtp : MCVideo mc\_granted ; mc\_implicit \_request ;$$

$$mc\_audio \_ssrc = 1024 ; mc\_video \_ssrc = 1048$$

2) Offer: without mc_granted, and MCVideo server returns same value back for both audio and video

$$m = application 1982 udp MCVideo$$

$$a = fmtp : MCVideo mc\_implicit \_request ; mc\_audio \_ssrc = 1024 ;$$

$$mc\_video \_ssrc = 1048$$

Answer:

$$m = application 2015 udp MCVideo$$

$$a = fmtp : MCVideo mc\_implicit \_request ; mc\_audio \_ssrc = 1024 ;$$

$$mc\_video \_ssrc = 1048$$

Below is an example for including media source identifiers in their respective m lines with reference to FIG. 5b.
1) Offer: with mc_granted and server returns same value back for both audio and video

$$m = audio 1982 RTP / AVP 105$$

$$a = ssrc : 1024 cname : MCVideoUser @ example . com$$

$$m = video 1992 RTP / AVP 97$$

$$a = ssrc : 1048 cname : MCVideoUser @ example . com$$

$$m = application 2002 udp MCVideo$$

$$a = fmtp : MCVideo mc\_granted ; mc\_implicit \_request$$

$$Answer :$$

$$m = audio 2015 RTP / AVP 105$$

$$m = video 2025 RTP / AVP 97$$

$$m = application 2035 udp MCVideo$$

$$a = fmtp : MCVideo mc\_granted ; mc\_implicit \_request ;$$

$$mc\_audio \_ssrc = 1024 ; mc\_video \_ssrc = 1048$$

2) Offer: without mc_granted and server returns same value back for both audio and video

$$m = audio 1982 RTP / AVP 105$$

$$a = ssrc : 1024 cname : MCVideoUser @ example . com$$

$$m = video 1992 RTP / AVP 97$$

$$a = ssrc : 1048 cname : MCVideoUser @ example . com$$

$$m = application 2002 udp MCVideo$$

$$a = fmtp : MCVideo mc\_implicit \_request$$

$$Answer :$$

$$m = audio 2015 RTP / AVP 105$$

$$m = video 2025 RTP / AVP 97$$

$$m = application 2035 udp MCVideo$$

$$a = fmtp : MCVideo mc\_implicit \_request ; mc\_audio \_ssrc = 1024 ;$$

$$mc\_video \_ssrc = 1048$$

In another example with reference to FIG. 5a, if the media source identifier value is already in use, the MCVideo server 104 generates a new media source identifier for both audio and video media. The MCVideo server 104 shares the newly generated media source identifiers to the client in 200 OK response. Also, the MCVideo server 104 can send the media source identifiers in the explicit transmission grant message. The same can be shown in an example as follows:
1) Offer: with mc_granted and server returns different value back for both audio and video

$$m = application 1982 udp MCVideo$$

$$a = fmtp : MCVideo mc\_granted ; mc\_implicit \_request ;$$

$$mc\_audio \_ssrc = 1024 ; mc\_video \_ssrc = 1048$$

Answer:

$$m = application 2015 udp MCVideo$$

$$a = fmtp : MCVideo mc\_granted ; mc\_implicit \_request ;$$

$$mc\_audio \_ssrc = 2048 ; mc\_video \_ssrc = 2096$$

2) Offer: without mc_granted and server returns different value back for both audio and video

$$m = application 1982 udp MCVideo$$

$$a = fmtp : MCVideo mc\_implicit \_request ; mc\_audio \_ssrc = 1024 ;$$

$$mc\_video \_ssrc = 1048$$

$$Answer :$$

$$m = application 2015 udp MCVideo$$

$$a = fmtp : MCVideo mc\_implicit \_request ; mc\_audio \_ssrc = 2048 ;$$

$$mc\_video \_ssrc = 2096$$

FIG. 5b depicts an example wherein media source identifiers are included in their respective m lines.
1) Offer: with mc_granted and server returns different value back for both audio and video

$$m = audio 1982 RTP / AVP 105$$

$$a = ssrc : 1024 cname : MCVideoUser @ example . com$$

$$m = video 1992 RTP / AVP 97$$

$$a = ssrc : 1048 cname : MCVideoUser @ example . com$$

$$m = application 2002 udp MCVideo$$

$$a = fmtp : MCVideo mc\_granted ; mc\_implicit \_request$$

Answer:

$$m = audio 2015 RTP / AVP 105$$

$$m = video 2025 RTP / AVP 97$$

$$m = application 2035 udp MCVideo$$

$$a = fmtp : MCVideo mc\_granted ; mc\_implicit \_request ;$$

$$mc\_audio \_ssrc = 2048 ; mc\_video \_ssrc = 2096$$

2) Offer: without mc_granted and server returns different value back for both audio and video

$$m = audio 1982 RTP / AVP 105$$

$$a = ssrc : 1024 cname : MCVideoUser @ example . com$$

$$m = video 1992 RTP / A VP 97$$

$$a = ssrc : 1048 cname : MCVideoUser @ example . com$$

$$m = application 2002 udp MCVideo$$

$$a = fmtp : MCVideo mc\_implicit \_request$$

$$Answer :$$

$$m = audio 2015 RTP / AVP 105$$

$$m = video 2025 RTP / AVP 97$$

$$m = application 2035 udp MCVideo$$

$$a = fmtp : MCVideo mc\_implicit \_request ; mc\_audio \_ssrc = 2048 ;$$

$$mc\_video \_ssrc = 2096$$

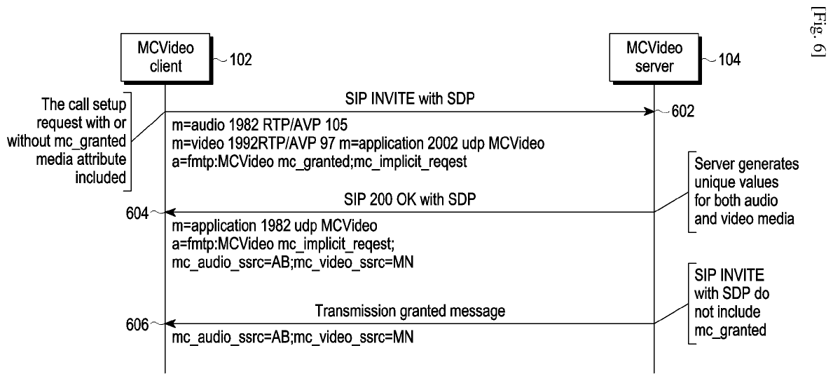

FIG. 6 illustrates an another alternate method for handling one or more media source identifiers of one or more MCVideo communication clients by the MCVideo server by generating unique media source identifiers for both audio and video media during call setup when the call setup is requested with implicit transmission request. A SIP invite request with SDP is transmitted to the MCVideo server 104 by the MCVideo client 102, as depicted in step 602. The call setup request with or without mc_granted media attribute included is transmitted to the MCVideo server 104.

The SDP included in the call setup request by the MCVideo client 102 does not include the media source identifier for both audio and video media, the generated values of unique media source identifiers are returned by the MCVideo server 104, as depicted in step 604 or as depicted in step 606. The MCVideo server 104 generates the uniquely differentiated media source identifier for both audio and video media for the participants, while setting up the MCVideo communication. The MCVideo server 104 uses the media plane control channel included in SDP with media attributes mc_audio_ssrc and mc_video_ssrc to return the media source identifiers for both or with any other media attribute name. The MCVideo server 104 can also use any other media line in SDP with media attributes mc_audio_ssrc and mc_video_ssrc to return the media source identifiers for both or with any other media attribute name. The MCVideo server 104 alternatively uses the explicit transmission grant message to return the uniquely differentiated media source identifier for both audio and video media for the participants.

In this example, the media source identifier can be generated by the MCVideo server 104 and the MCVideo server 104 returns the generated values of the unique media source identifier for both audio and video media. The MCVideo server 104 shares the media source identifiers to the MCVideo client 102 in 200 OK response. Also, the MCVideo server 104 can send the media source identifiers in the explicit transmission grant message, as depicted in step 606. The same can be exemplified as:
1) Offer: with mc_granted

$$m = application 1982 udp MCVideo$$

$$a = fmtp : MCVideo mc\_granted ; mc\_implicit \_request ;$$

$$Answer :$$

$$m = application 2015 udp MCVideo$$

$$a = fmtp : MCVideo mc\_granted ; mc\_implicit \_request ;$$

$$mc\_audio \_ssrc = 1024 ; mc\_video \_ssrc = 1048$$

2) Offer: without mc_granted

$$m = application 1982 udp MCVideo$$

$$a = fmtp : MCVideo mc\_granted ; mc\_implicit \_request ;$$

$$Answer :$$

$$m = application 2015 udp MCVideo$$

$$a = fmtp : MCVideo mc\_granted ; mc\_implicit \_request ;$$

$$mc\_audio \_ssrc = 1024 ; mc\_video \_ssrc = 1048$$

Therefore, the proposed system 100 provides various mechanisms in which the media source identifier can be determined and provided with the unique differentiating media source identifier for each of audio and video media for an initiator of a MCVideo communication with implicit transmission request as a part of call setup request. Once the unique differentiating media source identifier for each of audio and video media for an initiator of MCVideo communication is received, the RTP packets should use the corresponding media source identifier for audio and video media.

The proposed system 100 provides a standard way in a MCVideo service for the granted transmission participant with a uniquely differentiable media source identifier, if the MCVideo communication setup is initiated along with implicit transmission request, wherein the media source identifier can be used for sending audio and video media data using RTP packets.

The system 100 ensures uniqueness of media source identifier for both audio and video media usage within and across the MCVideo communication. The system 100 uses new media level attributes (i.e., “a=ssrc”, mc_audio_ssrc and mc_video_ssrc) in the SDP offer-answer message flows. In the proposed system 100, the initiator of the MCVideo communication is provided with the option to indicate the synchronization source (SSRC) value to be used for audio and video RTP packets and the MCVideo server 104 can determine whether to use the offered value or generate new values so that MCVideo communication initiator can use them when they are returned back.

The proposed system 100 can be used in public safety and railway applications where this feature allows the public safety users to migrate to partner system and communicate with primary system users or partner system users.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein describes a system 100 and method 200, 300, and 400 for uniquely differentiating media source identifiers of MCVideo communication participants, thereby avoiding collision of media source identifiers which are used in the RTP packets. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

According to an embodiment of the disclosure, a method (200) for handling one or more media source identifiers of one or more Mission Critical Video (MCVideo) communication clients may include receiving, by a MCVideo server (104), at least one call setup request initiated by at least one MCVideo client (102) for a MCVideo communication session, and the at least one call setup request comprises at least one of an audio media data, and a video media data.

According to an embodiment of the disclosure, the method (200) may include generating, by the MCVideo server (104), at least one unique media source identifier for the at least one of the audio media data, and the video media data.

According to an embodiment of the disclosure, the method (200) may include sending, by the MCVideo server (104), the generated at least one unique media source identifier to the at least one MCVideo client (102) in at least one call setup response.

According to an embodiment of the disclosure, the at least one call setup request may be initiated with an implicit transmission request, wherein the at least one call setup request comprises at least one media source identifier for the at least one of the audio media data, and the video media data.

According to an embodiment of the disclosure, the method (200) may include determining, by the MCVideo server (104), whether the at least one media source identifier for the at least one of the audio media data, and the video media data is uniquely differentiable.

According to an embodiment of the disclosure, the method (200) may include returning, by the MCVideo server (104), the at least one media source identifier to the at least one MCVideo client (102) in the at least one call setup response, if the at least one media source identifier for the at least one of the audio media data, and the video media data is uniquely differentiable.

According to an embodiment of the disclosure, the method (200) may include generating, by the MCVideo server (104), the at least one unique media source identifier for the at least one of the audio media data, and the video media data, if the at least one media source identifier for the at least one of the audio media data, and the video media data is not uniquely differentiable.

According to an embodiment of the disclosure, the method (200) may include sending, by the MCVideo server (104), the generated at least one unique media source identifier to the at least one MCVideo client (102) in the at least one call setup response.

According to an embodiment of the disclosure, the method (200) may include including, by the at least one MCVideo client (102), the generated at least one unique media source identifier in one or more Real-time Transport Protocol (RTP) packets.

According to an embodiment of the disclosure, the method (200) may include transmitting, by the at least one MCVideo client (102), at least one of an audio, and a video using the one or more RTP packets during the MCVideo communication session.

According to an embodiment of the disclosure, the at least one media source identifier, and the at least one unique media source identifier may be included in a Session Description Protocol (SDP).

According to an embodiment of the disclosure, the method (200) may include one of: populating, by the at least one MCVideo client (102), the at least one media source identifier in the SDP using a media attribute a=ssrc for each media line (m-line) for the at least one of the audio media data, and the video media data; and adding, by the at least one MCVideo client (102), the at least one media source identifier to the m-line of a media plane control channel in the SDP, for the at least one of the audio media data, and the video media data, using mc_audio_ssrc, and mc_video_ssrc media attributes.

According to an embodiment of the disclosure, the MCVideo server (104) may return at least one of the at least one media source identifier and the generated at least one unique media source identifier to the at least one MCVideo client (102) with the media plane control channel using the mc_audio_ssrc and mc_video_ssrc media attributes.

According to an embodiment of the disclosure, the MCVideo server (104) may transmit at least of the at least one media source identifier, and the at least one unique media source identifier to the at least one MCVideo client (102) in an explicit transmission grant message, if an mc_granted media attribute is not included in the SDP of at least one of the at least one call setup request, and the at least one call setup response, or the mc_granted media attribute is supported.

According to an embodiment of the disclosure, a Mission Critical Video (MCVideo) server (104) may include a processor (112), configured to: receive at least one call setup request initiated by at least one MCVideo client (102) for a MCVideo communication session, wherein the at least one call setup request comprises at least one of an audio media data, and a video media data; generate at least one unique media source identifier for the at least one of the audio media data, and the video media data; and send the generated at least one unique media source identifier to the at least one MCVideo client (102) in at least one call setup response.

According to an embodiment of the disclosure, the at least one call setup request may be initiated with an implicit transmission request, wherein the at least one call setup request comprises at least one media source identifier for the at least one of the audio media data, and the video media data.

According to an embodiment of the disclosure, the processor (112) may be configured to: determine whether the at least one media source identifier for the at least one of the audio media data, and the video media data is uniquely differentiable; and return the at least one media source identifier to the at least one MCVideo client (102) in the at least one call setup response, if the at least one media source identifier for the at least one of the audio media data, and the video media data is uniquely differentiable.

According to an embodiment of the disclosure, the processor (112) may be configured to: generate the at least one unique media source identifier for the at least one of the audio media data, and the video media data, if the at least one media source identifier for the at least one of the audio media data, and the video media data is not uniquely differentiable; and send the generated at least one unique media source identifier to the at least one MCVideo client (102) in the at least one call setup response.

According to an embodiment of the disclosure, the at least one MCVideo client (102) may be configured to: include the generated at least one unique media source identifier in one or more Real-time Transport Protocol (RTP) packets; and transmit at least one of an audio, and a video using the one or more RTP packets during the MCVideo communication session.

According to an embodiment of the disclosure, the at least one media source identifier, and the at least one unique media source identifier may be included in a Session Description Protocol (SDP).

According to an embodiment of the disclosure, the at least one MCVideo client (102) may be configured for performing one of: populate the at least one media source identifier in the SDP using a media attribute a=ssrc for each media line (m-line) for the at least one of the audio media data, and the video media data; and add the at least one media source identifier to the m-line of a media plane control channel in the SDP, for the at least one of the audio media data, and the video media data, using mc_audio_ssrc and mc_video_ssrc media attributes.

According to an embodiment of the disclosure, the MCVideo server (104) may return at least one of the at least one media source identifier and the generated at least one unique media source identifier to the at least one MCVideo client (102) with the media plane control channel using the mc_audio_ssrc and mc_video_ssrc media attributes.

According to an embodiment of the disclosure, the MCVideo server (104) may transmit at least of the at least one media source identifier, and the at least one unique media source identifier to the at least one MCVideo client (102) in an explicit transmission grant message, if an mc_granted media attribute is not included in the SDP of at least one of the at least one call setup request, and the at least one call setup response, or the mc_granted media attribute is supported.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1. A method performed by a mission critical video (MCVideo) server, comprising:
receiving at least one call setup request initiated by at least one MCVideo client, wherein the at least one call setup request comprises a session description protocol (SDP) offer, and wherein the SDP offer comprises at least one of an audio media data, or a video media data;
generating value information related to the at least one of the audio media data, or the video media data; and
sending the value information to the at least one MCVideo client.

2. The method of claim 1, wherein the at least one call setup request is initiated with an implicit transmission request, wherein the at least one call setup request comprises at least one media source identifier for the at least one of the audio media data, or the video media data.

3. The method of claim 2, comprising:
determining whether the at least one media source identifier for the at least one of the audio media data, or the video media data is uniquely differentiable; and
returning the at least one media source identifier to the at least one MCVideo client in at least one call setup response, if the at least one media source identifier for the at least one of the audio media data, or the video media data is uniquely differentiable.

4. The method of claim 3, comprising:
generating the at least one unique media source identifier for the at least one of the audio media data, or the video media data, if the at least one media source identifier for the at least one of the audio media data, or the video media data is not uniquely differentiable; and
sending the generated at least one unique media source identifier to the at least one MCVideo client in the at least one call setup response.

5. The method of claim 1, wherein the SDP offer comprises at least one media source identifier, or the at least one unique media source identifier.

6. The method of claim 1, wherein the MCVideo server transmits at least one of at least one media source identifier, or at least one unique media source identifier to the at least one MCVideo client in an explicit transmission grant message, if an mc_granted media attribute is not included in an SDP of at least one of the at least one call setup request, or the at least one call setup response, or the mc_granted media attribute is supported.

7. A mission critical video (MCVideo) server, comprising:
at least one processor, and
memory storing instructions that, when executed by the at least one processor, cause the MCVideo server, to:
receive at least one call setup request initiated by at least one MCVideo client, wherein the at least one call setup request comprises a session description protocol (SDP) offer, and wherein the SDP offer comprises at least one of an audio media data, or a video media data;
generate value information related to the at least one of the audio media data, or the video media data; and
send the value information to the at least one MCVideo client.

8. The MCVideo server of claim 7, wherein the at least one call setup request is initiated with an implicit transmission request, wherein the at least one call setup request comprises at least one media source identifier for the at least one of the audio media data, or the video media data.

9. The MCVideo server of claim 8, wherein the processor is configured to:
determine whether the at least one media source identifier for the at least one of the audio media data, or the video media data is uniquely differentiable; and
return the at least one media source identifier to the at least one MCVideo client in she at least one call setup response, if the at least one media source identifier for the at least one of the audio media data, or the video media data is uniquely differentiable.

10. The MCVideo server of claim 9, wherein the processor is configured to:
generate the at least one unique media source identifier for the at least one of the audio media data, or the video media data, if the at least one media source identifier for the at least one of the audio media data, or the video media data is not uniquely differentiable; and
send the generated at least one unique media source identifier to the at least one MCVideo client in the at least one call setup response.

11. The MCVideo server of claim 7, wherein the at least one MCVideo client is configured to:
generate one or more real-time transport protocol (RTP) packets including at least one unique media source identifier; and
transmit at least one of an audio, or a video using the one or more RTP packets during an MCVideo communication session.

12. The MCVideo server of claim 7, wherein the SDP offer comprises at least one media source identifier, or at least one unique media source identifier.

13. The MCVideo server of claim 12, wherein the at least one MCVideo client is configured for performing one of:
populate the at least one media source identifier in the SDP using a media attribute a=ssrc for each media line (m-line) for the at least one of the audio media data, or the video media data; and
add the at least one media source identifier to the m-line of a media plane control channel in an SDP, for the at least one of the audio media data, or the video media data, using mc_audio_ssrc or mc_video_ssrc media attributes.

14. The MCVideo server of claim 13, wherein the MCVideo server returns at least one of the at least one media source identifier or the generated at least one unique media source identifier to the at least one MCVideo client with the media plane control channel using the mc_audio_ssrc or mc_video_ssrc media attributes.

15. The MCVideo server of claim 7, wherein the MCVideo server transmits at least one of the at least one media source identifier, or and the at least one unique media source identifier to the at least one MCVideo client in an explicit transmission grant message, if an mc_granted media attribute is not included in an SDP of at least one of the at least one call setup request, or the at least one call setup response, or the mc_granted media attribute is supported.
